(19) United States
(12) Patent Application Publication
(10) Pub. No.: US 2003/0214100 A1
(43) Pub. Date: Nov. 20, 2003

(54) Packing seal assembly for use with reciprocating cylindrical bodies

(76) Inventor: Frederick B. Pippert, Sugar Land, TX (US)

Correspondence Address: Browning Bushman P.C., Suite 1800, 5718 Westheimer, Houston, TX, 77057, US

(21) Appl. No.: 10/429,631

(22) Filed: May 5, 2003

Related U.S. Application Data
(60) Provisional application No. 60/377,853, filed on May 3, 2002.

(51) Int. Cl. F16J 15/18

(52) U.S. Cl. 277/510

(57) ABSTRACT

Axially spaced, pressure-energized seals in a sealing assembly are carried in a conventional seal assembly housing. The seals surround a rod that reciprocates through the housing to power a fluid pump. The seals are pressure-energized by a flowable sealant that is injected through the housing into a confined annular area defined between the seals. The sealant maintains worn seals in close sealing engagement with the reciprocating rod to prevent fluid or pressure loss from the pump. The sealant pressure resists the repeated flexing stresses exerted by the axial rod movement to minimize seal fatigue wear. Components of the seal assembly may be split to permit seal repair or replacement without requiring the removal of the rod from the assembly. The pressure and composition of the flowable, injectable sealant cooperate with the split seal assembly components to prevent leakage across the seal component splits.

### CROSS REFERENCE TO RELATED APPLICATIONS

This application claims the benefit of U.S. Provisional Patent Application Serial No. 60,377,853 filed May 3, 2002.

### FIELD OF THE INVENTION

The present invention relates to packing or sealing assemblies primarily for use on reciprocating shafts or rods, as for example, for sealing between the stuffing box and the polished rod of a jack pump.

### BACKGROUND SETTING OF THE INVENTION

In many mechanical devices employing rods or cylindrical shafts, (herein usually referred to as “rods”) that are used to move or pump fluids, it is frequently necessary to have a sealing or packing assembly surrounding the rod to prevent fluid leakage from the pump. For example, in the case of so-called “jack pumps” or “rod pumps” used to pump oil from a well, a rocking beam reciprocates a polished rod supporting a string of sucker rods. To prevent loss of oil or other production fluids, the polished rod extends through a stuffing box assembly that provides a sliding, fluid tight sealing between the reciprocating polished rod and the stationary stuffing box.

Aside from jack pumps, reciprocating rods and shafts are found in plunger pumps, as for example mud pumps used in the drilling of oil and gas wells, as well as numerous other applications. In these plunger pumps, which operate at high pressures, the reciprocating pump rod extends through a seal assembly into the pump body. The seal assembly contains packing and/or other sealing components to ensure fluid-tight and pressure-tight sealing between the stationary pump body and the reciprocating pump rod.

Where reciprocating rods, plungers or the like are being employed as part of an assembly to transfer fluids, the seals used in the packing assemblies that engage and seal against the reciprocating rods can wear rapidly depending upon pressure and temperature conditions, the nature of the fluid being handled and other such considerations. Wear in the seal assembly eventually leads to fluid leakage and/or pressure loss between the rod and the seal assembly.

While wear is a problem in both rotating and reciprocating rods, a problem associated with reciprocating rods that is not found with rotating rods is that the material of the packing and seals engaging the external cylindrical surface of a reciprocated rod is stressed back and forth axially as the rod reciprocates. The material of the packing and seals engaging a rotating shaft is exposed to only a unidirectional stress that does not cause the same wear or fatigue damage as that experienced by reciprocating seal assemblies. Additionally, the motion and pressure-induced forces acting on the seals engaging a reciprocating rod are different at each end of the seal assembly causing uneven wear between the high pressure end seal and the low pressure end seal. This results from the fact that a rod moving along its longitudinal axis and operating between high and low pressure areas imposes different stresses on the rod seals as the rod advances into the high-pressure area or retracts into the lower pressure area.

The non-symmetrical application of stress in seals of reciprocating rods can compound the fatigue damage and wear in the seals as compared with the seals used with rotating rods. In many applications, the failure rate of the seals in reciprocating rod devices is significantly higher than that of an equivalent rotating shaft device. Any improvement in the seal life of a reciprocating rod device can provide valuable savings in downtime and repair costs.

Repair of damaged or worn seals in a reciprocating rod device can be difficult and expensive if the repair procedure requires the removal of the rod from its stuffing box. If the seal components are continuous, annular bodies, there is no alternative to removal of the rod from the stuffing box during the repair procedure. Certain conventional seals used in rod pumps are effective only as continuous, annular bodies. Replacement or repair of this type seal assembly requires that the reciprocating rod device be removed from service and disassembled so the rod may be inserted through the center opening of the annular replacement seal.

Accordingly, it would be desirable to have a packing or sealing assembly that would extend the life of the seals in a reciprocating rod device. It would also be desirable to have a reciprocating rod seal design that can be used in the previously described environments where the sealing assembly could be repaired or replaced while the pump or the like device continued to operate. The ability to repair the seal assembly for a reciprocating rod pump without requiring complete disassembly of the seal assembly and retraction of the rod from the seal assembly would be particularly advantageous in the case of assemblies such as jack pumps where such in situ repairing can be extremely cost effective.

It would also be desirable to have a means to repair or replace the sealing components contained within the housings of conventional seal assemblies without first having to remove the rod from the sealing assembly.

### SUMMARY OF THE INVENTION

The axially spaced seals surrounding a reciprocating rod are pressure-energized by a flowable sealant that is injected under pressure into a confined annular area defined between the seal components. The pressurized sealant maintains the spaced seals in close sealing engagement with the reciprocating rod as the seals wear. The pressure of the flowable sealant resists the collapsing and flexing stresses exerted by the axial rod movement to minimize fatigue wear of the seal. Components of the seal assembly may be split to permit repair or replacement of a seal assembly without requiring the removal of the rod from the assembly. The split components of the seal assembly can be used to repair or replace the sealing components contained within the housing of a conventional stuffing box without first having to remove the rod from the housing. The pressure and composition of the flowable, injectable sealant cooperate with the split seal assembly components to prevent leakage across the seal component splits.

From the foregoing it will be appreciated that a primary object of the present invention is to provide an improved seal assembly for a rod designed to reciprocate in a surrounding relatively stationary device.

An object of the present invention is to provide a replaceable seal assembly having an improved life span as compared with a seal assembly conventionally used to seal a reciprocating rod.

Another object of the present invention is to provide a seal assembly for a reciprocating rod device that can be repaired or replaced without first removing the rod from the device.

Yet another object to the present invention is to provide a self-energizing seal assembly for sealing a housing about a cylindrical body reciprocating in the housing.

It is also an object of the present invention to provide a seal assembly that can automatically compensate for wear caused by the movement of a reciprocating cylindrical body moving along its central axis concentrically within the central opening of a seal assembly.

An object of the present invention is to provide a renewable pressurized sealing assembly for sealing a reciprocating cylindrical body with a surrounding housing whereby the sealing effectiveness of the assembly may be periodically enhanced by applying a pressurized, injectable sealant into the sealing assembly.

It is an object of the present invention to provide a seal assembly for a reciprocating rod wherein the seal assembly is energized by a pressurized sealant to resist the flexing stresses imposed by reciprocation of the rod and to increase the pressure sealing capacity of the seal.

A further object of the present invention is to provide a replaceable stuffing box seal that can be interposed between a reciprocating pump jack polished rod and a stuffing box without disconnecting the pumping rod string from the pump jack.

Still another object the present invention is to provide a seal assembly for a conventional polished rod stuffing box used with a jack pump wherein a replacement seal assembly having split seal components can be installed in the stuffing box without removing the polished rod from the stuffing box.

Another object to the present invention is to provide an injectable, pressurizeable sealant in a conventional stuffing box housing whereby the sealant cooperates with split seal assemblies in the stuffing box housing to prevent leakage through the splits in the seal assemblies.

An important object of the present invention is to provide axially spaced lip seals around a reciprocable cylindrical body with a pressurizeable sealant disposed in the axial space between the lip seals whereby the pressure of the sealant activates the lip seals to engage and seal with the cylindrical body as it is reciprocated.

The foregoing features, advantages and objects of the present invention will be more fully appreciated and better understood by reference to the following drawings, specification and claims.

### BRIEF DESCRIPTION OF THE DRAWINGS

FIG. 1 is a cross-sectional view of a conventional round stuffing box including a sealing assembly of the present invention;

FIG. 2 is a view similar to FIG. 1 illustrating a variation of a sealing assembly of the present invention in a conventional round stuffing box;

FIG. 3 is a cross-sectional view of a stuffing box employing a sealing assembly of the present invention in a cartridge form;

FIG. 4 is a cross-sectional view of a typical prior art stuffing box assembly used with pumps as, for example, plunger pumps; and

FIG. 5 is a view similar to FIG. 4 illustrating a sealing assembly of the present invention deployed in a conventional prior art stuffing box housing.

### DESCRIPTION OF THE ILLUSTRATED EMBODIMENTS

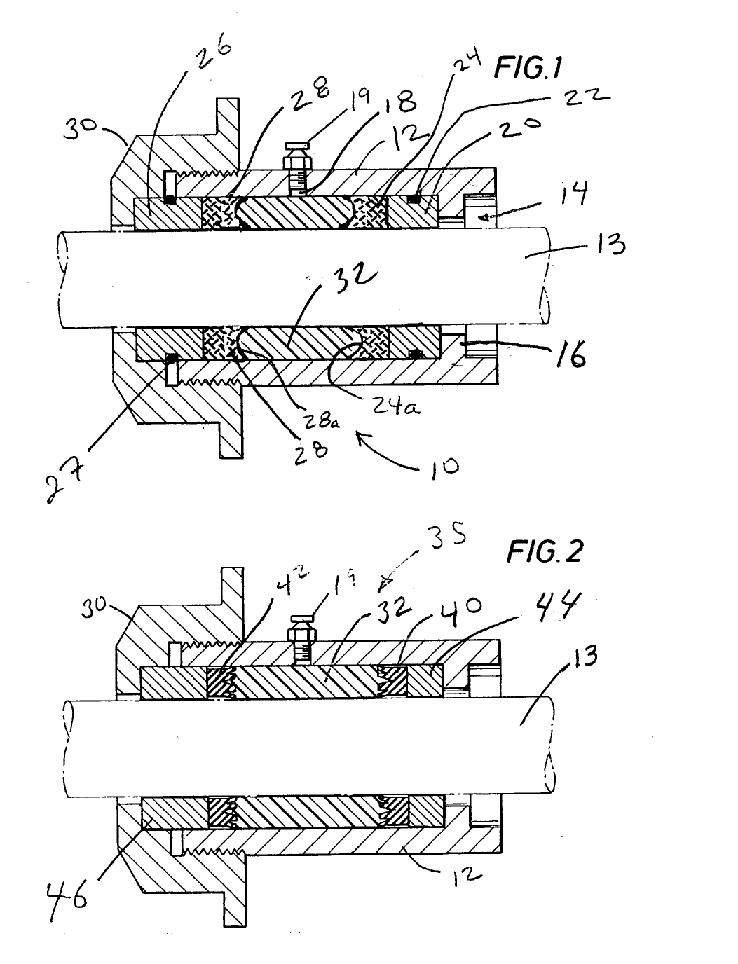

Referring first to FIG. 1, there is illustrated a typical round stuffing box, indicated generally at 10, that may be employed with a conventional jack pump or rod pump used to extract oil and other liquids from wells. The stuffing box 10 includes a tubular housing 12 that forms a passageway 14 through which a cylindrical pump rod 13 reciprocates. The stuffing box housing may be constructed of steel, brass or other suitable material. The housing 12 includes a radially inwardly extending annular ledge 16 at one axial housing end. The housing 12 is also provided with a port 18 that extends through the housing wall. A one-way flow grease fitting, or buttonhead, 19 is threaded into the port 18 for injection of a flowable sealant into the stuffing box.

Disposed in the housing 12 is a split metal adapter ring 20 that engages the annular ledge 16. The ring 20 may be constructed of steel, brass or any other suitable material. The two semicircular halves of the split adapter ring 28 are held together about the rod 13 with a snap ring 22, or other suitable device. Engaging the internal axial end of the adapter ring 20 is an annular, fabric or fiber heeled, flexible elastomeric lip-type seal 24. The seal 24 may be constructed of a layered and/or composite construction of suitable rigid, semi-rigid, and flexible materials as required to provide the necessary sealing and wear characteristics.

The seal 24 has a substantially square cross-sectional configuration with an internally facing, flexible concave axial end surface 24a. A second split adapter ring 26, similar to the adapter ring 20, engages a second flexible annular seal 28, similar to the seal 24. The seal 28 has an internally facing concave axial end surface 28a. The seals 24 and 28 are axially spaced from one another to effectively form an annular sealing space between the pump rod 13 and the housing 12. The opposed concave seal faces 24a and 28a provide curving, axial end barriers and pressure lip seals to the annular seal space.

The assembly 10 further includes a gland 30 threadedly engaged with the housing 12 to provide axial containment of the packing material in the housing. The gland 30 may be constructed of steel, brass or other suitable material. Contained within the annular space between seal rings 24 and 28 is an injectable sealant or packing 32 that can be injected into the annular sealing space through the grease fitting 19.

The seal rings 24 and 28 may generally be formed of molded thermoplastics or composites thereof that may include fabric reinforcement or various other combinations of materials commonly used to make seals. The injectable sealant 32 injected through the grease fitting 19 is preferably comprised of a carrier or binder containing greases, oils and other viscous polymers in which are suspended a blend of fibers and other filler materials that act as barriers to leakage. A suitable such injectable sealant is sold under the trademark U-Pak® by Utex Industries, Inc. of Houston, Tex.

The seal rings 24 and 28 are not continuous rings, but rather have had their circular bodies cut or split to permit them to be opened and wrapped around the rod 13. When in place, the seal rings encircle the rod with the respective ends of each seal ring abutting. The surface configurations at the abutting ends of the seal rings conform to mesh together with minimum separation when the rings are assembled about the rod 13. Splitting the sealing components of the assembly 10 permits the sealing assembly in the housing 12 to be repaired or replaced without first having to remove the rod 13 from the stuffing box. As a result, an in situ seal repair or replacement may be made without necessitating the complete shutting down and/or disassembly of the jack pump rod string.

In replacing worn or damaged packing from a conventional stuffing box, the gland 30 is unscrewed from the stuffing box housing 12 and moved along the rod 13 axially away from the housing top. The internal components of the worn stuffing assembly are then removed from the housing 12. The split ring 22 is then assembled about the rod 13 and the snap ring 22 is applied to hold the two half-ring segments together around the rod. The ring 22 is then moved to the bottom of the housing 12. The seal ring 24, which is initially in the form of a curved strip of sealing material with an end face at each end of the strip, is then wrapped about the rod 13 so that the two ends of the seal strip abut. The thus positioned ring 24 is then moved along the rod 13 and inserted into the housing 12. Sealant material 32 is placed in the housing 12 in an amount sufficient to fill the housing to a level that covers the port 18. The material may be injected with any suitable device including a hand or power activated grease gun, or may be introduced through the open end of the housing. The seal ring 28 is then wrapped around the rod 13 and inserted into the housing. The two halves of the adapter ring 26 are then placed about the rod 13 and held together with a snap ring 27. The assembled adapter ring 26 is moved along the rod 13 into the position illustrated in FIG. 1. The gland 30 is then moved down along the rod 13 and threadedly engaged with the top of the housing 12. Sealant material 32 is then injected through the fitting 19 into the annular area defined between the seal rings. The sealant material is preferably brought to a pressure that closely approximates the anticipated working pressure of the pump.

The pressure of the injectable packing 32 works against the concave end surfaces 24a and 28a to force the internally facing circumferential edges of the seal rings radially apart into tight sealing engagement with the surrounding housing 12 and the central rod 13. The seal rings 24 and 28 are thus pressure energized as they wear away to maintain sealing contact with the moving rod 13 as it reciprocates. The injectable packing 32 can be injected under pressure into the annular seal space periodically as required to maintain the pressure necessary to force the seal surfaces radially against the rod 13.

While the injectable packing 32 is viscous, it contains fibers and other solid fillers that prevent it from easily extruding past the cut seal strip ends or escaping through worn seals. Indeed, because the injectable packing 32 can be pressured-up, it can be injected at a pressure that effectively matches or exceeds the fluid pressure against which it is to seal. This capability reduces the load on the seal rings 24 and 28 thereby relieving some of the workload on the seal rings. It also improves the pressure capacity of the seal so that the stuffing box may be used in higher-pressure applications than are normally possible with conventional sealing arrangements. The pressurizing sealing method of the present invention further acts to extend the life of the primary seal rings 24 and 28 by reducing the magnitude of the alternating stresses induced in the seals resulting from the reciprocating rod motion. This reduction in fatigue-induced damage cooperates with the consistent renewal of the sealing pressure on the wearing seals to extend the service life of the packing assembly.

Referring now to FIG. 2, there is illustrated another round stuffing box, indicated generally at 35, for use with rod pumps or jack pumps. These substantially rectangular cross-sectional configuration seals of FIG. 1 are replaced in FIG. 2 by lip-type seal rings 40 and 42, which are axially spaced from one another defining an internal annular space for the injectable packing material 32. Metal adapter rings 44 and 46 engage the external axial end of the lip seals 40 and 42, respectively.

The lip seal rings 40 and 42 have a complex, substantially concave axial end surface engaging the sealant material 32. The seal surface engaging the sealant 32 is designed to respond to pressure in the sealant material to exert radially directed forces through the seals against the surrounding housing wall and the external surface of the rod 13. The lip seals 40 and 42 can be made of various materials as described above with respect to the seals 24 and 28. In this regard, it should be observed that various materials may be employed in constructing the seals 22, 28, 40 and 42 and the materials of construction of such seals are well known to those skilled in the art. By way of example rather than limitation, the materials of construction can range anywhere from simple elastomeric materials such as rubber to thermoplastics materials and to materials of more complex construction, e.g., seals made of combinations of braided materials and various thermoplastic resins, etc.

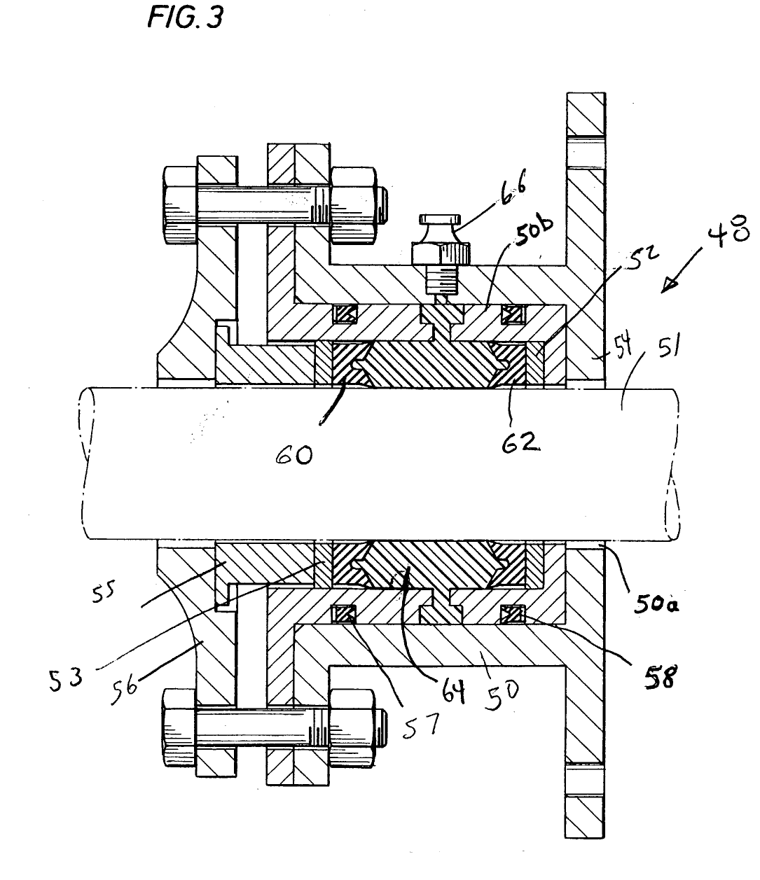

FIG. 3 illustrates a modified form of the invention, indicated generally at 48, in which the sealing assembly of the present invention is employed in the form of a cartridge. The assembly 48 illustrated in FIG. 3 is particularly suited for use as a retro-fit replacement or repair device for use in a conventional stuffing box having a housing 50 designed to contain a seal assembly for sealing with a polished rod 51. Such housings may have a large gap 50a between the reciprocating rod and the solid metal base of the housing. The large annular gap between the rod and housing body can make it difficult for the seal elements of the present invention to be axially retained as required to maintain their sealing effectiveness when they are subjected to the pressurizing effect of the injectable sealant that forces the seals axially apart.

The assembly 48 includes a cartridge insert liner 50b that is nested in the housing 50. The base of the insert liner 50b rests against a central annular ledge 54 extending about a central opening in the base of the housing 50. Two axially spaced backup bushing rings 52 and 53 are positioned within the liner 50b. The backup rings cooperate with the restricted central opening through the base of the insert 50b to reduce the annular gap between the housing 50 and the rod 51. The backup bushing 53 engages the base of a retrofit gland follower 55, which in turn engages an adjustable retrofit gland 56. The backup bushing 53 may also be provided with a restricted central opening as required to provide a sufficient backing structure for the internal sealing components of the assembly 48.

The assembly 48 is provided with secondary containment seals 57 and 58 that maintain a pressure seal between the packing cartridge liner 50b and the housing 50. In addition, there are primary containment seals 60 and 62 of the lip type, and more specifically of the Chevron type, that are disposed in the annular space between the cartage liner 50b and the polished rod 51, the primary containment seals being oriented with their concave surfaces facing each other and axially spaced as illustrated. Disposed in the annulus between the primary containment seals is injectable packing material 64, previously described. The gland 56 may be adjusted to advance the gland follower 55 axially as desired to properly space the seal assembly components axially and to increase the contained pressure within the assembly.

The injectable sealant is applied through a one-way flow injection fitting such as a grease fitting 66. The sealant injected through the fitting 66 flows through the same radial port that had originally been employed to supply lubricant to the conventional seal assembly previously contained within the stuffing box housing 50. The fluid is contained in the annular area between the stuffing box and the external surface of the polished rod 51 by means of the various annular seals 60, 62, 57 and 58 and the one-way valving action of the fitting 66. As the lips of the seal components 60 and 62 wear because of their sliding engagement with the reciprocating rod 51, the pressure of the sealant 64 acts against the concave facing surfaces of the seals to maintain radial forces engaging the seals with the rod surface. These radial forces are maintained even as portions of the seal in contact with the reciprocating rod wear because of the ability of the primary seals to distend radially under the influence of the pressurized sealant.

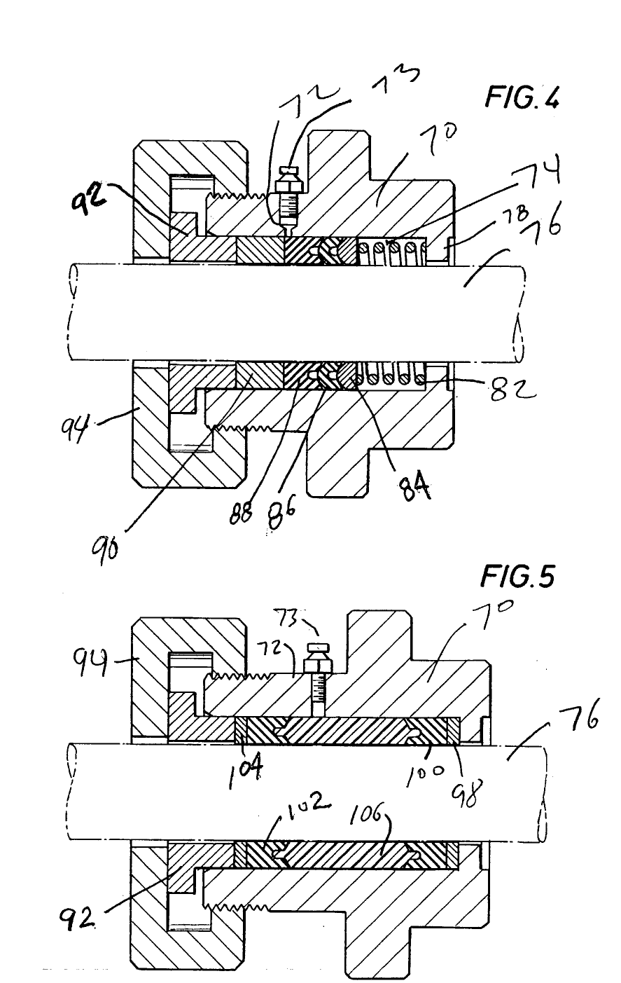

Referring now to FIG. 4, there is illustrated a prior art stuffing box of the type that is commonly used in a plunger pump or other similar pump. The assembly illustrated in FIG. 4 comprise a housing 70 through which is formed a lubrication port 72. A grease fitting 73 is threaded into the port 72. The lubrication port 72 communicates with an internal annular space 74 formed between the housing 70 and a pump rod 76. Disposed in the annular space 74 is a retaining ledge 78 against which rests the base of a coil spring 82. The opposite end of the spring 82 engages a metal adapter ring 84, which in turn engages a first seal ring 86. The seal ring 86 engages a second seal ring 88.

As illustrated in the drawings, seal rings 86 and 88 are generally of the lip-type having radially inner and radially outer sealing lips. A metallic spacer 90 engages the seal ring 88. The spacer 90 is in turn engaged by a standard gland follower 92 that is in turn engaged by a gland 94 threadedly secured to the housing 70.

As the seal rings 86 and 88 wear, they must be adjusted to prevent leakage between the seal rings and the pump rod 76. The axial position of the gland 94 and the gland follower 92 is adjusted as required to maintain sealing engagement of the seals between the stuffing box housing 70 and the rod 76. When the seal surfaces engaging the rod 76 wear to the point that the combined axial forces imposed by the gland and gland follower and the resilient bias of the coil spring 82 are no longer capable of maintaining sufficient radially directed sealing forces against the internal housing wall and the external surface of the pump rod, the sealing components of the assembly of FIG. 4 must be replaced.

Referring now to FIG. 5, the sealing assembly of the present invention is illustrated in position within the housing 70 of the conventional stuffing box illustrated in FIG. 4. The sealing assembly of FIG. 5 includes a first annular bushing ring 98 that engages an annular lip-type seal 100. A second such bushing ring 104 is axially spaced from the ring 98 to define the axial ends of an annular sealant containment space between the housing 70 and the pump rod 76. The axial end of an annular lip seal 102 engages the second bushing 104, which in turn is engaged by the gland follower 92. As with the previously described embodiments of the present invention, the axially extending annular space between the annular lipals 100 and 104 is filled with an injectable, flowable packing material 106 that is introduced via the one-way flow injection valve 73. Injecting additional pressurized sealant material 106 into the annular sealing space defined by the lip seals, the stuffing box housing and the pump rod periodically refreshes the seal of the present invention.

The pressurized sealant functions to pressure-energize the lip seals 100 and 102 to maintain them in constant sealing contact with the internal wall of the surrounding housing 70 and to maintain a constant sliding and sealing contact with the pump rod 76. The composition of the pressurized sealant is preferentially selected to include a suitable lubricant to eliminate the requirement for periodically lubricating the packing assembly as is common in conventional stuffing box devices.

While specific forms of the present invention have been described in detail herein, it will be appreciated that various modifications in the design, manufacture and use of the invention may be made without departing from the spirit of the present invention. By way of example, rather than limitation, the various pressure energized sealing components can be configured from layered materials, composite materials, and combinations thereof. The sealing portions of the assemblies may also be provided as single, pre-assembled units rather than individual, separately assembled parts. While the description has been made primarily with reference to stuffing boxes used in jack pumps employed in the pumping of oil from wells and to reciprocating plunger pumps, it will be appreciated that the invention may be applied in any environment where an axially movable, cylindrical body is to be pressure sealed relative to a structure through which the body reciprocates.

1. A seal assembly for sealing between a housing and a cylindrical body in which the cylindrical body is reciprocated, comprising:
an axially extending housing,
a cylindrical body extending axially within said housing, said cylindrical body having a cylindrical outer surface movable axially relative to said housing,
first and second axially spaced housing end closures connected with said housing and extending about said cylindrical outer surface of said cylindrical body to define an axially limited annular seal space between said housing and said cylindrical outer surface of said cylindrical body,
an annular packing assembly interposed radially in said seal space for providing a fluid seal between said housing and said cylindrical outer surface of said cylindrical body to prevent axial fluid flow between said cylindrical outer surface and said housing in an axial direction through said first or second end closures,
a first annular seal component in said first housing end closure for sealing between said housing and said outer cylindrical surface of said cylindrical body,
a second annular seal component in said second housing end closure for sealing between said housing and said outer cylindrical surface of said cylindrical body,
said first and second annular seal components constructed of a solid, non-flowing packing material and having facing concave axial end surfaces, and
a third annular seal component disposed axially intermediate said first and second annular seal components said third annular seal material comprising an injectable, pressurizeable, flowable packing material forming an annular ring extending radially between said outer cylindrical surface and said housing for pressure energizing said first and second annular seals to assist in preventing axial flow of fluid through said first or second housing end closures.

2. A seal assembly as defined in claim 1 further comprising an injection passage in said seal assembly for supplying said flowable packing material to said third seal component.

3. A seal assembly as defined in claim 1 further comprising a retrofit packing cartridge disposed within said housing for converting a conventional seal assembly to a seal assembly having said third annular sealing component, said third annual sealing component being disposed intermediate said packing cartridge and said cylindrical outer surface of said cylindrical body.

4. A seal assembly as defined in claim 3 further comprising axially spaced cartridge seals disposed between said packing cartridge and said housing cooperating with said first, second and third seal components for preventing axial fluid flow between said cylindrical outer surface and said housing through said first or second end closures.

5. A seal assembly as defined in claim 4 further comprising an injection passage extending through said packing cartridge intermediate said cartridge seals for communicating with said injection passage to supply flowable packing material from said injection passage to said third annular sealing component.

6. A seal assembly as defined in claim 5 wherein said first housing end closure comprises a gland movable relative to said second housing end closure for confining material disposed in said annular seal space.

7. A seal assembly is defined in claim 1 wherein said first and second seal components comprise lip seals having opposed, substantially concave axial end surfaces in contact with said third sealing component.

8. A seal assembly as defined in claim 1 wherein each of said lip seals comprises an elongate body configured in a circular arrangement with ends of the elongate body abutting to form a ring.

9. A seal assembly as defined in claim 8 wherein split backing rings are positioned against axial ends of said first and second seal components.

10. A seal assembly as defined in claim 3 wherein said first and second seal components comprise lip seals having opposed, substantially concave axial end surfaces in contact with said third sealing component.
